(19) United States
(12) Patent Application Publication
(10) Pub. No.: US 2022/0360651 A1
(43) Pub. Date: Nov. 10, 2022

(54) METHOD AND SYSTEM FOR SEQUENCING USER DATA PACKETS

(71) Applicant: Zeku Inc., Palo Alto, CA (US)

(72) Inventors: Hausting HONG, San Diego, CA (US); Su-Lin LOW, San Diego, CA (US); Tianan Tim MA, San Diego, CA (US)

(21) Appl. No.: 17/814,051

(22) Filed: Jul. 21, 2022

Related U.S. Application Data
(63) Continuation of application No. PCT/IB2020/058506, filed on Sep. 14, 2020.
(60) Provisional application No. 62/964,810, filed on Jan. 23, 2020.

(51) Int. Cl. H04L 69/322; H04L 69/22

(52) U.S. Cl. CPC H04L 69/322; H04L 69/22; H04W 80/02

(57) ABSTRACT

A method and a system for sequencing user data packets are provided. The method includes the following. A user data packet including a packet data convergence protocol (PDCP) data packet data unit (PDU) header is received at hardware of a sublayer of a data link layer. The PDCP data PDU header is decoded at the sublayer to obtain a sequence number of the user data packet. The received user data packet is queued at the sublayer according to the sequence number of the user data packet to assemble a set of consecutively numbered user data packets. At least a portion of the set of consecutively numbered user data packets is delivered from the sublayer to another sublayer of the data link layer.

### CROSS-REFERENCE TO RELATED APPLICATION(S)

This application is a continuation of International Application No. PCT/IB2020/058506, filed Sep. 14, 2020, which claims priority to U.S. Provisional Application No. 62/964,810, filed Jan. 23, 2020, the entire disclosures of which are incorporated herein by reference.

### TECHNICAL FIELD

The disclosed teachings relate to wireless communication. More particularly, the disclosed teachings relate to a method and system for sequencing user data packets.

### BACKGROUND

Wireless network systems, generally, have two communication paths: uplink and downlink. During uplink, data is transmitted from the mobile station (e.g., a cell phone) to a base station (e.g., a cell site). During downlink, data is transmitted from a base station to a mobile station. The data packets being transmitted during uplink and downlink encapsulate control data on a control plane and/or user data on a data plane. Control data provides data for identifying, selecting, executing, or modifying another set of data. User data contains the content to be transmitted to the base station or mobile station.

In the downlink of the data plane, the wireless receiver receives data packets at a sublayer of a multi-layer protocol stack. Each protocol sublayer can perform tasks such as reading and removing headers, organizing data content, or differentiating between user data and control packets. After the tasks are performed at a sublayer, the data packets are passed to another sublayer, which performs its own tasks. As such, the data packet is parsed through a hierarchical multi-layer protocol stack.

### SUMMARY

In a first aspect, a method for sequencing user data packets is provided. The method includes the following. A user data packet including a packet data convergence protocol (PDCP) data packet data unit (PDU) header is received at hardware of a sublayer of a data link layer. The PDCP data PDU header is decoded at the sublayer to obtain a sequence number of the user data packet. The received user data packet is queued at the sublayer according to the sequence number of the user data packet to assemble a set of consecutively numbered user data packets. At least a portion of the set of consecutively numbered user data packets is delivered from the sublayer to another sublayer of the data link layer.

In a second aspect, a method for sequencing user data packets is provided. The method includes the following. Multiple data packets are received at a hardware of a sublayer of a data link layer, where each data packet includes a PDCP header and a radio link control (RLC) header, and where each data packet includes a PDCP data PDU. For each data packet: the PDCP header is decoded at the sublayer to determine that the data packet includes a data PDU rather than a control PDU, the RLC header is decoded at the sublayer to determine that the data packet includes an unsegmented PDCP data PDU rather than a segmented PDCP data PDU, and in response to determining that the data packet includes the PDCP data PDU that is unsegmented, the PDCP header is decoded at the sublayer to obtain a sequence number of the PDCP data PDU. The multiple data packets are queued at the sublayer according to the sequence number of each PDCP data PDU of the multiple data packets to assemble at least a portion of a set of consecutively numbered PDCP data PDUs. Cause, at the sublayer, another sublayer of the data link layer to receive the at least the portion of the set of consecutively numbered PDCP data PDUs.

In a third aspect, a system for sequencing user data packets is provided. The system includes: a processor; and a memory having instructions stored thereon that, when executed by the processor, cause the system to: receive, at a hardware of a sublayer of a data link layer, a user data packet including a PDCP data PDU header, decode, at the sublayer, the PDCP data PDU header to obtain a sequence number of the user data packet, queue, at the sublayer, the received user data packet according to the decoded sequence number of the user data packet to assemble a set of consecutively numbered user data packets, and deliver, at the sublayer, at least a portion of the set of consecutively numbered user data packets to another sublayer of the data link layer.

### BRIEF DESCRIPTION OF THE DRAWINGS

The present embodiments are illustrated by way of examples and are not intended to be limited by the figures in the accompanying drawings.

FIG. 1 illustrates a protocol stack of a 5th Generation New Radio system and that processes data packets.

FIG. 2 illustrates a process for sequencing Packet Data Convergence Protocol (PDCP) data Packet Data Units (PDUs) at a Medium Access Control (MAC) sublayer.

FIG. 3 is a flowchart that illustrates a method for sequencing PDCP data PDUs at a MAC sublayer.

FIG. 4 is a block diagram illustrating a diagrammatic representation of a machine in the example form of a computer system operable to perform aspects of the disclosed technology.

### DETAILED DESCRIPTION

Introduced here is at least one technique for processing data packets through a protocol stack of a 5th generation new radio system. A technique can include, for example, the hardware that implements a sublayer (e.g., Medium Access Control) of a data link layer receiving a user data packet which includes a packet data convergence protocol (PDCP) data packet data unit (PDU) header. The sublayer can decode the PDCP data PDU header to obtain the sequence number of the user data packet. Based on the sequence number, the sublayer can queue the user data packet to assemble a set of consecutively numbered user data packets. At least a portion of the set of consecutively numbered user data packets can be delivered to another sublayer of the data link layer. In another example, the user data packet can also include a radio link control (RLC) header. The sublayer can decode the RLC header to determine that the user data pack is unsegmented. Additionally, the sublayer can decode the PDCP data PDU header to determined that user data packet is not a control data packet.

Introduced here are systems and method for improving the traditional multi-step approach to sequencing data packets that arrive unsegmented at a sublayer of layer 2 of a 5G new radio system. The techniques taught here are applied at the sublayer when two conditions are satisfied: first, the data packets are unsegmented; and second, the data packets are user data packets, rather than control data packets. If both conditions are met, the hardware that implements the sublayer decodes the PDCP header to determine the sequence number of the user data packet. With the sequence number, the hardware maps the sequence number to a queue location and inserts the user data packet into the queue location. These techniques can be applied to multiple data packets so as to form a sequence of consecutively numbered user data packets, which can be forwarded to another sublayer of layer 2.

In telecommunications, 5G networks are digital cellular networks which use cell radio waves for communication between mobile devices and local antennas. The local antennas are connected with a telephone network and the Internet by a high-bandwidth optical fiber or wireless backhaul connection. The communication between a mobile device and local antenna is governed by a layered architecture, with each layer having its own protocol stack. A protocol stack of a 5G new radio system can be separated into host layers and media layers. Media layers include layers 1 to 3 and host layers include layers 4 to 7.

Layer 1 is commonly referred to as the physical layer and its function is to transmit and receive raw bit streams over a physical medium. Layer 2 is the data link layer and performs reliable transmission of the data frames between two nodes connected by layer 1. Layer 3 is the network layer and manages a multi-node network by addressing, routing, and controlling traffic. The remaining layers, in general, are related to the transportation, exchange, presentation, and application of data between nodes.

More specifically, layer 2 of a 5G new radio (NR) system contains a protocol stack including four sublayers: medium access control (MAC), radio link control (RLC), packet data convergence protocol (PDCP), and service data adaptation protocol (SDAP). The MAC sublayer controls the hardware responsible for interaction with the transmission medium. The RLC sublayer, among other tasks, segments and resizes data packets for transmission to another sublayer. The PDCP sublayer transfers user data and control data to other sublayers while compressing and ciphering the user and control data. The SDAP sublayer is responsible for quality of service flow handling across the air interface.

In the downlink of the data plane in layer 2, two types of data packets can arrive at the MAC sublayer: control data and user data (also referred to as data packet data unit, PDCP data packet data unit, or user data packet). Control data is used for identifying, selecting, executing, or modifying another set of data. User data contains the payload (e.g., text message, picture, video). User data and control data must be distinguished because the protocol sublayers perform different tasks with each type of data. Specifically, the user data packets need to be sequenced.

Sequencing of user data packets can be done based on the sequence number (SN) of the user data packet. During transmission, the order of the user data packet can get randomized due to data loss during transmission or data packets taking multiple paths within the network. Thus, the user data packets need to be sequenced in order for the user data packets to arrive at the end-user in the same sequence that they are sent. For example, a text message would not be comprehendible to a receiver of the text message if the words or letters are not in order. In another example, an image would not be recognizable if the pixels were randomly placed. In order to avoid such errors, the user data packets need to be sequenced.

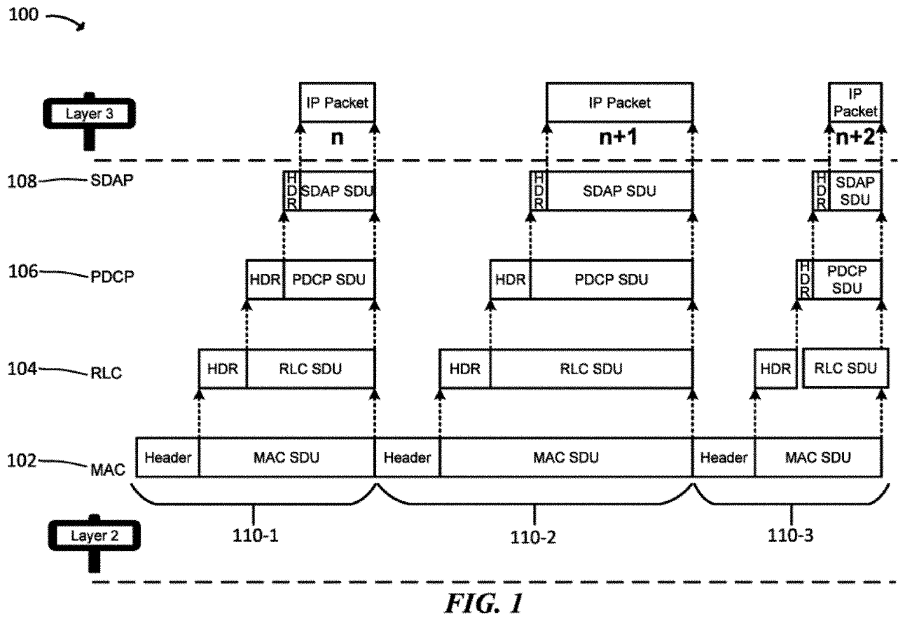

FIG. 1 illustrates a protocol stack of a 5G NR system that processes data packets. As shown, protocol stack 100 includes sublayers of layer 2 of the 5G NR system. The protocol stack 100 includes MAC sublayer 102, RLC sublayer 104, PDCP sublayer 106, and SDAP sublayer 108. These sublayers are ordered in a sequence, as shown in FIG. 1. In particular, the MAC sublayer is the lowest sublayer in layer 2, the next sublayer is the RLC sublayer, then the PDCP sublayer, then closest to layer 3, is the SDAP sublayer.

Each sublayer is illustrated as having multiple user data packets 110-1 through 110-3 with associated headers and service data units (SDUs). Generally, an SDU encapsulates the header and SDU of the subsequent sublayer. For example, a MAC SDU encapsulates the RLC header and RLC SDU. Subsequently, the RLC SDU encapsulates the PDCP header and PDCP PDU. The PDCP SDU encapsulates the SDAP header and SDAP SDU.

In order to sequence user data packets 110-1 through 110-3, the SNs of the user data packets 110-1 through 110-3 are mapped to a memory location. For example, a user data packet 110-1 can have a sequence number of 15, which can be mapped to a memory location associated with SN 15. The traditional approach for sequencing user data packets 110-1 through 110-3 (by mapping the user data packets 110-1 through 110-3 to a memory location) includes a three-step process involving each sublayer of layer 2.

First, hardware that implements the MAC sublayer 102 reads and removes the MAC header from the user data packet 110-1 and notifies the RLC sublayer 104 that the user data packet 110-1 is incoming. Second, hardware that implements the RLC sublayer 104 reads and removes the RLC header from the user data packet 110-1 and routes the user data packet 110-1 to the PDCP sublayer 106. Third, the PDCP sublayer 106 receives the user data packet 110-1, parses the PDCP header to obtain the SN of the user data packet 110-1, and inserts the user data packet 110-1 into a corresponding memory location based on the SN. After the user data packet 110-1 is inserted into the corresponding memory location, user data packets 110-2 and 110-3 may be inserted into their corresponding memory locations to form a sequence. Once the sequence is formed, the user data packets 110-1 through 110-3 can be transmitted to the SDAP sublayer 108.

Further, user data packets 110-1 through 110-3 can be unsegmented or segmented when they arrive at the MAC sublayer 102. The RLC header of a user data packet includes information which indicates whether the user data packet is segmented or unsegmented. For example, user data packet 110-1 can arrive at the RLC sublayer 104 from the MAC sublayer 102. The hardware that implements the RLC sublayer 104 can then read the RLC header of the user data packet 110-1 to determine that it is segmented. Because the user data packet 110-1 is segmented, the PDCP sublayer 108 may not have to sequence the user data packet 110-1 upon arrival at the PDCP sublayer 108.

Alternatively, the hardware that implements the RLC sublayer 104 can determine, based on reading the RLC header of user data packet 110-2, that user data packet 110-2 is unsegmented. Due to being unsegmented, the PDCP sublayer 108 can read the PDCP header of the user data packet 110-2 to determine its SN, map the SN to a memory location, and insert the user data packet 110-2 into the memory location.

Further, for each newly arriving user data packet, the PDCP sublayer 106 maps the user data packet to the corresponding memory location. The traditional method is to compare the SN of the newly arrived user data packet with each previously inserted user data packet to determine the memory location corresponding the SN of the newly arrived user data packet. For example, the PDCP sublayer 106 can be storing nine user data packets when the tenth user data packet arrives. The nine user data packets can have SNs from 21 through 29. The SN of the newly arrived user data packet can be 20. Thus, in the traditional approach, the SN of the newly arrived user data packet is compared with each user data packet, starting with the user data packet with SN 29. Through this process, the newly arrived user data packet will eventually be inserted in a memory location neighboring the user data packet with SN 21. This step-by-step process inefficiently uses the capabilities of the hardware at each protocol layer, and inefficiently uses bus cycles and power to sequence the user data packets.

Therefore, the traditional multi-step approach takes time (e.g., bus cycles) and power to sequence the user data packets prior to transmission to the SDAP sublayer 108. Time and power are valuable resources in a 5G new radio system. Accordingly, it is desirable to provide methods that reduce the time and power consumption caused by the traditional multi-step approach.

Introduced here are techniques for improving the traditional multi-step approach to sequencing unsegmented data packets. The disclosed embodiments make it possible for a MAC sublayer to receive unsegmented data packets and transmit an ordered sequence of user data packets from the MAC sublayer directly to the PDCP sublayer. In particular, the disclosed embodiments use hardware that implements the MAC sublayer to perform tasks that were previously performed by multiple successive sublayers. The processing at the MAC sublayer is triggered when two criteria are satisfied. First, the hardware that implements the MAC sublayer can decode the RLC header to determine whether the data packet is unsegmented and, second, the hardware that implements the MAC sublayer decode the PDCP header to determine whether the data packet is a user data packet. If these two criteria are satisfied, the hardware that implements the MAC sublayer can then decode the PDCP header to determine the SN of the user data packet. Subsequently, the hardware that implements the MAC sublayer can match the SN with a memory location (also referred to herein as slot). The user data packet can then be inserted into the memory location for subsequent delivery to another sublayer (e.g., SDAP sublayer) of the protocol stack. In some cases, multiple data packets can be inserted in an ordered sequence of slots based on their sequence numbers and delivered as a sequence of ordered data packets to the SDAP sublayer.

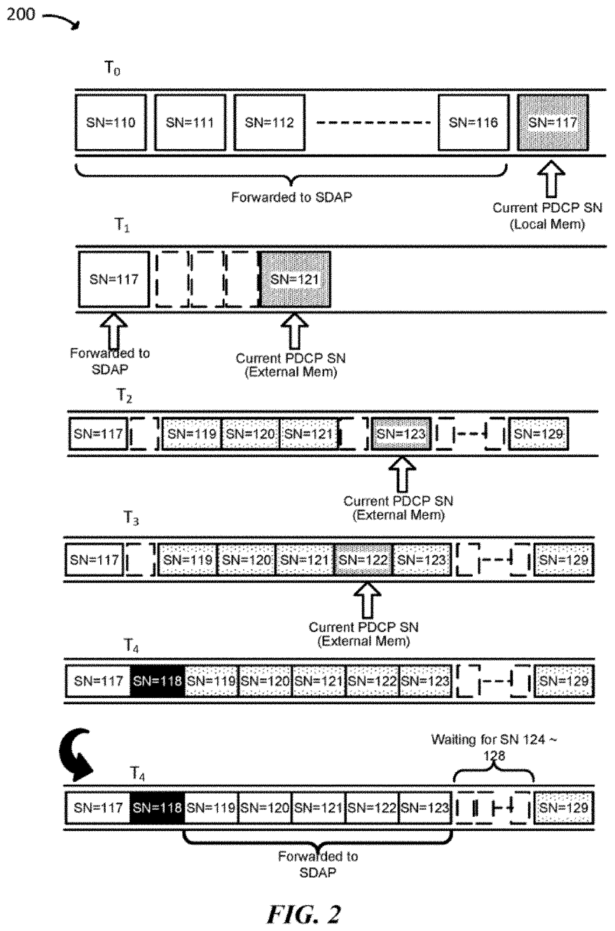

FIG. 2 illustrates a process for sorting a sequence of PDCP data PDUs at a MAC sublayer. The process is illustrated along a timeline 200 that includes times T₀, T₁, T₂, T₃, and T₄. Timeline 200 depicts the events that occur at the MAC sublayer when user data packets arrive. In particular, FIG. 2 includes the arrangements of a sequence of user data packets at each time instance. At To, a sequence of user data packets with SNs 110 through 116 are inserted in memory locations that correspond to the SN of the user data packets. As such, they are forwarded to the SDAP sublayer. Also, at To, the data packet with SN 117 arrives at the MAC sublayer 102.

Prior to performing the techniques described herein for transmitting an ordered sequence of user data packets to the PDCP sublayer, the hardware that implements the MAC sublayer analyzes the user data packets to determine whether they satisfy two criteria. First, the hardware decodes the RLC header to determine that the user data packet is unsegmented (e.g., not in an ordered sequence). Second, the hardware decodes the PDCP header to determine that the user data packet is a user data and not a control data. Following the two checks, if the hardware determines that the user data packet is both unsegmented and a user data packet, the hardware can trigger the techniques described herein.

For example, a data packet can arrive at the MAC sublayer. The hardware that implements the MAC sublayer can determine whether the data packet satisfies the two criteria. The hardware may determine by decoding the RLC header that the data packet is segmented; in which case, the data packet progresses in a manner that is known in the art. In another case, the hardware may determine that the data packet is unsegmented but after decoding the PDCP header, the hardware may determine that the data packet is a control data packet. Again, the data packet will progress in a manner that is known in the art. In another case, if the hardware determines that the data packet is both unsegmented and a user data packet, then the techniques described herein can be initiated.

The hardware that implements the MAC sublayer then decodes the PDCP header to determine the SN of the user data packet. With the SN information, the MAC sublayer maps the SN to a memory location and inserts the user data packet into the memory location. For example, a user data packet can arrive at the MAC sublayer. The MAC sublayer can then decode the PDCP header to determine that the SN of user data packet is 30. With the SN information, the MAC sublayer can create a slot in the memory that is associated with SN 30 and insert the user data packet into the memory slot. Thus, when the user data packet arrives at the PDCP sublayer, the PDCP sublayer does not have to waste bus cycles to sequence the user data packet in relation to other user data packets. For instance, the next user data packets can have SNs 31 and 32. Thus, the MAC sublayer can directly insert the user data packets in the associated memory slots and transmit them to the PDCP sublayer in an ordered sequence. Here, for instance, the user data packet with SN 30 can be inserted in a first memory location, the user data packet with SN 31 can be inserted in a second neighboring memory location, and the user data packet with SN 32 can be inserted in the third memory location.

In some embodiments, a user data packet can be stored in local or external memory. The decision of where to store the user data packet is based on the need to efficiently use local memory because local memory does not have a large capacity, when compared to external memory. Thus, it can be more efficient to use the limited capacity of local memory for user data packets that are ready to be transmitted to the SDAP sublayer. At T₀, for instance, SN 117 is the next data packet that needs to be forwarded to the SDAP sublayer. Thus, it can be stored in local memory.

In the illustrated example, at T₀, the sequence of user data packets with SN 110 through 116 can be forwarded to the SDAP sublayer due to the determination that a minimum number of user data packets have been placed in an ordered sequence. The minimum number of user data packets can be, for example, pre-programmed during the development of the protocol stack. For instance, the minimum number of in-sequence user data packets can be seven. Thus, without having to wait for the user data packet with SN 117, the sequence can be forwarded to the SDAP sublayer. Alternatively, the minimum number can be eight, in which case, the system would wait until the user data packet with SN 117 arrives. In some embodiments, the MAC sublayer forwards user data packets directly to the SDAP sublayer. This can occur, for example, when there is a sequence of user data packets as in To (e.g., SN 110 to SN 116). Alternatively, the data packet can be forwarded to the PDCP sublayer.

In some embodiments, a complete sequence of ordered user data packets may not be necessary prior to being forwarded to the SDAP sublayer. A single user data packet can be forwarded to the SDAP sublayer if the single user data packet has a SN that is the next SN after the previously forwarded sequence. For example, at T₁, the user data packet with SN 117 is forwarded to the SDAP sublayer. SN 117 is the next in the sequence after the previously forwarded user data packets (e.g., SN 116).

In the illustrated example, the MAC sublayer creates slots in the memory for missing user data packets. For example, at T₁, the user data packet with SN 117 has been forwarded to the SDAP sublayer and the next user data packet to arrive has SN 121. Accordingly, the MAC sublayer creates slots from SN 118 through SN 121, inserts the newly arrived user data packet at the slot associated with SN 121, and leaves the remaining slots 118, 119, and 120 empty. Additionally, due to the empty slots, the data packet with SN 121 can be stored in external memory in order to avoid using the local memory while waiting to receive the user data packets corresponding to the empty slots.

At T₂, more out-of-sequence user data packets arrive. Similar to T₁, the MAC sublayer 102 can create slots for the entire sequence from SN 118 through SN 129. In the sequence, some of the slots can be filled with user data packets, while others are empty. The MAC sublayer can be aware of the empty slots and not forward the sequence of slots to another sublayer. In some embodiments, the decision to forward or not forward a sequence with empty slots can depend on the SN associated with the empty slots. For example, the MAC sublayer can decide not to forward a sequence of data packets if a slot associated with a smaller and neighboring SN is empty. For example, at T₂, the slot associated with SN 118 is empty; thus, the slots associated with SN 119 through 121 are not forwarded. In some embodiments, if the empty slot is associated with a higher and neighboring SN, then the sequence of user data packets can be forwarded to another sublayer.

At T₃, the user data packet with SN 122 is inserted into the associated empty slot to form a sequence of user data packets from SN 119 to SN 123. However, the user data packet associated with SN 118 has not arrived yet. The MAC sublayer can decide to not forward the sequence of user data packets because a slot associated with a smaller and neighboring SN (e.g., SN 118) remains empty. Additionally, the user data packet with SN 129 has been inserted into a slot but it is not forwarded to another sublayer. This can be because the slot is not in sequence with other filled slots, or the slot is not the next SN in relation to the prior sequence of user data packets that was forwarded.

In some embodiments, user data packets that form a sequence can continue to be stored in external memory. At T₃, the user data packet with SN 122 is stored in external memory even though it forms a sequence with the neighboring user data packets. The MAC sublayer 106 can decide to do this because the sequence is not going to be forwarded until the user data packet with SN 118 arrives. Thus, due to the limited capacity of local memory, it is more efficient to store user data packet with SN 122 in external memory.

At T₄, the user data packet with SN 118 has still not arrived. The MAC sublayer uses a timer to decide when to abort waiting for a missing user data packet (e.g., SN 118). The timer can be a decrementing timer which starts from a pre-programmed value and decrements for each bus cycle. For example, a decrementing timer can be programmed to count down from a starting value of two. The timer can subtract one for each bus cycle. The timer can start, for example, when there is a sequence of two or more in-sequence user data packets, when there is only one user data packet missing between the previously forwarded sequence and the not-forwarded sequence (e.g., SN 118), or other similar reasons. In FIG. 2, for example, a decrementing timer may have started at T₂ with a starting value of two. The timer may have decremented by one at T₃ and again at T₄. At T₄, the timer has reached zero, and the user data packet with SN 118 has not arrived yet. Thus, the MAC sublayer 102 can determine that the user data packet with SN 118 is a permanent loss and forwards user data packets with SN 119 through 123 to the SDAP sublayer.

In some embodiments, the timer can be an incrementing timer which has a pre-programmed maximum value. For instance, the MAC sublayer can be programmed to wait ten bus cycles before deeming a missing user data packet as a permanent loss. In some embodiments, the starting value or ending value of a timer can be dependent on the number of missing user data packets. For example, each missing user data packet can be equated to a wait time of two bus cycles. As such, if there are three missing user data packets between the previously forwarded sequence and current sequence, a decrementing timer will start at six, while an incrementing timer will start at zero and count to six.

In some embodiments, the missing user data packet (e.g., SN 118), may arrive after the timer has reached zero and the neighboring user data packets have been forwarded. In this case, the MAC sublayer can, for example, forward the user data packet once it arrives, store it in external or local memory, consider it a permanent loss, or other similar options. After forwarding the user data packets and determining that the user data packet with SN 118 is a permanent loss, the MAC sublayer progresses to receiving the user data packets corresponding to the next set of slots (e.g., SN 124 to 128).

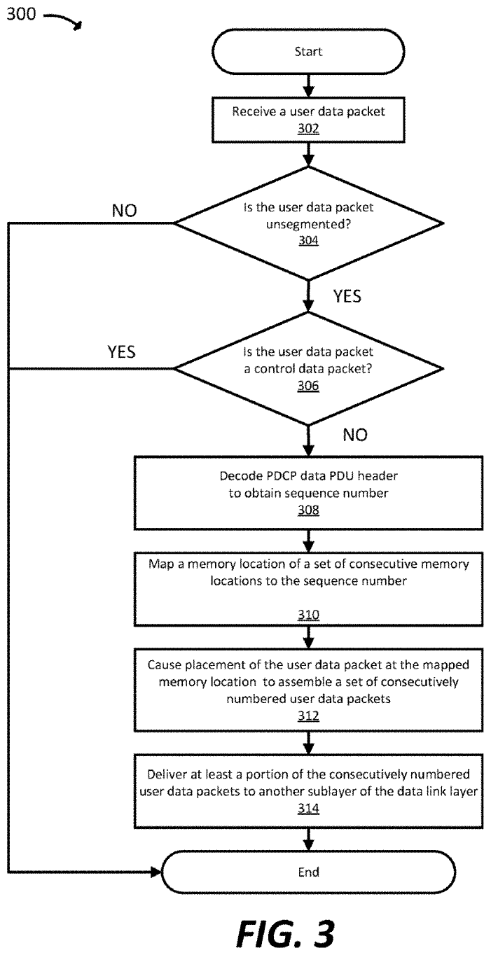

FIG. 3 is a flowchart that illustrates a method for sequencing of PDCP data PDUs at a MAC sublayer. The method(s) shown in FIG. 2 can be implemented by a 5G new radio system at the MAC sublayer of the data link layer (e.g., layer 2). For example, the system can be a handheld mobile device which includes a processor and memory. The memory can store instructions, when executed, can cause the processor to perform the method(s) illustrated in FIG. 2. The memory can be external or local memory that can communicate with the processor via a communication interface.

At 302, the system receives a user data packet (e.g., PDCP data PDU). In some embodiments, the system is the hardware that implements a sublayer (e.g., MAC sublayer) of a protocol stack. In some embodiments, the system can receive multiple data packets. Each of the data packets can include, for example, a PDCP header, RLC header, and a PDCP data PDU. At 304, the system determines whether the user data packet is unsegmented or segmented. To do so, the system decodes the RLC header of the user data packet. If the user packet is segmented, then the method terminates. Conversely, if the user data packet is unsegmented, the system proceeds to 306.

At 306, the system determines whether the user data packet is a control data packet or not. To do so, the system decodes the PDCP header of the user data packet. This can include differentiating between control data and user data. If the user data packet is a control data packet, the method terminates. Alternatively, if the user data packet is not a control data packet, then the system proceeds to 308.

At 308, the system decodes the PDCP header of the user data packet to obtain the sequence number of the user data packet. At 310, the system queues the user data packet according to the decoded sequence number. Queueing the user data packet can include mapping a queue location of a set of consecutive queue locations to the sequence number. A queue is, for example, a line or sequence of stored data that is retrievable in an order. Thus, a queue location is a location in the queue. In some embodiments, a queue location can be one location in the memory of a device amongst a queue or sequence of memory locations within the device. In some embodiments, the system can map multiple queue locations to the sequence numbers of multiple user data packets. Queueing the user data packet can also include placing the user packet at the queue location that is mapped to the sequence number of the data packet. In some embodiments, by filling the queue location with the user data packet, the system may form a set of consecutively numbered user data packets. In some embodiments, the system may not have received user data packets for every location in the set of consecutive queue locations. Nevertheless, the system may map consecutive sequence numbers to consecutive queue locations. In which case, after placing the consecutively numbered user data packets in the queue locations, then system will form, at least a portion, of a set of consecutively numbered user data packets.

In some embodiments, the system may receive a new user data packet with a sequence number that is not consecutive with the sequence number of the earlier user data packet. When this occurs, the system may map the new user data packet to a queue location based on its sequence number. In addition, the system may determine that there is at least one intermediate queue location between the new user data packet and the earlier user data packet. Further, the new user data packet and earlier user data packet can form a set of consecutive queue locations, which include intermediate queue locations which do not have user data packets and both user data packets.

In some embodiments, the system may determine that queue locations between two sets of consecutively numbered user data packets are empty. Similar to when there are single user data packets, separated by empty queue locations, the system may still form one set of consecutive queue locations which includes the two sets of consecutively numbered user data packets and the empty queue locations in between.

In some embodiments, when there are empty queue locations between two user data packets that have been placed in queue locations, the system may store the placed user data packets in the external memory. In some embodiments, when there are queue locations in a set of consecutive queue locations that are not filled with user data packets, the system may initiate a timer. The timer may then communicate with the processor regarding when to proceed. In some embodiments, the system may not initiate a timer based on the number of empty queue locations or the location in the sequence of the empty queue location. For example, if there are two or more empty queue locations between sets of consecutive queue locations that are filled with user data packets, the system may not initiate the timer. In another example, if the empty location is the second-to-last queue location in a set of consecutive queue locations that are filled, the system may initiate the timer. If the timer expires before the empty queue location(s) is filled with user data packets, the system can proceed to 312. If the empty queue location(s) is filled prior to the timer expiring, the system can proceed to 312.

At 312, the system delivers at least a portion of the consecutively numbered user data packets to another sublayer (e.g., SDAP sublayer) of the data link layer. In some embodiments, the other sublayer can receive the user data packets from the RLC sublayer. In some embodiments, a system may receive a new user data packet with a sequence number that is consecutive to the previously delivered set of user data packet. In this case, the system may deliver the new user data packet, individually, to the other sublayer. In some embodiments, prior to delivering the set of consecutively numbered user data packets, the system may store the user data packets in local memory. After delivery to another sublayer, the method is complete.

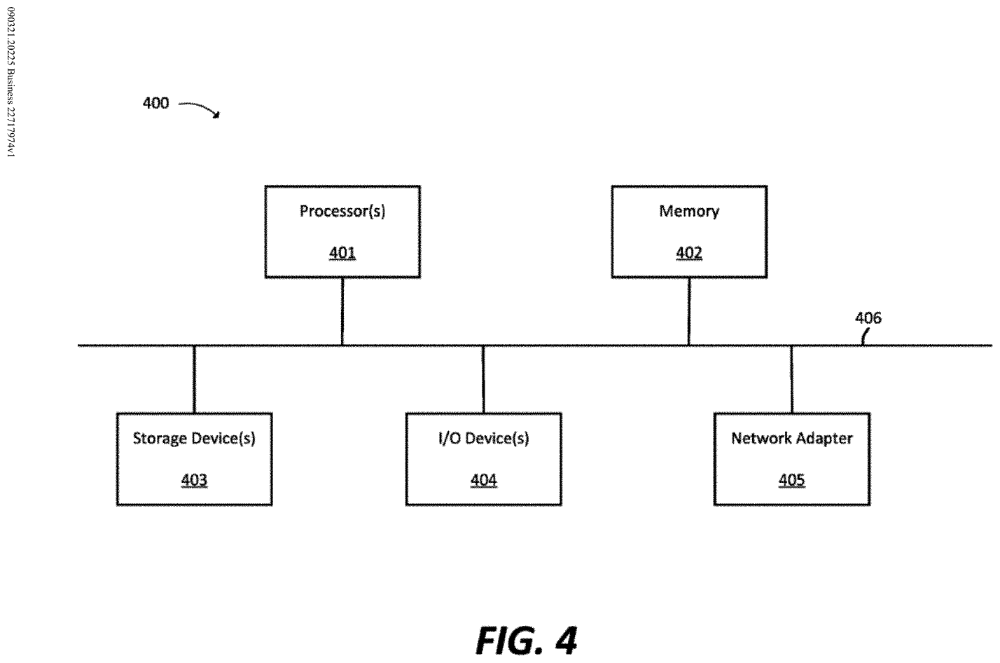

FIG. 4 is a block diagram illustrating a diagrammatic representation of a machine in the example form of a computer system operable to perform aspects of the disclosed technology. The computing system 400 may be a 5G NR system, components of a 5G NR system, a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a handheld console, a (handheld) gaming device, a music player, any portable, mobile, handheld device, wearable device, or any machine capable of executing a set of instructions, sequential or otherwise, that specify actions to be taken by that machine.

The computing system 400 may include one or more central processing units (“processors”) 401, memory 402, input/output devices 404 (e.g., keyboard and pointing devices, touch devices, display devices), storage devices 403 (e.g., disk drives), and network adapters 405 (e.g., network interfaces) that are each connected to an interconnect 406. The interconnect 406 is illustrated as an abstraction that represents any one or more separate physical buses, point to point connections, or both connected by appropriate bridges, adapters, or controllers. The interconnect 406, therefore, may include, for example, a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (e.g., Firewire).

The memory 402 and storage devices 403 are computer-readable storage media that may store instructions that implement at least portions of the various embodiments. In addition, the data structures and message structures may be stored or transmitted via a data transmission medium (e.g., a signal on a communications link). Various communications links may be used (e.g., the Internet, a local area network, a wide area network, or a point-to-point dial-up connection). Thus, computer readable media can include computer readable storage media (e.g., non-transitory media) and computer readable transmission media.

The instructions stored in memory 402 can be implemented as software and/or firmware to program the processor 401 to carry out actions described above. In some embodiments, such software or firmware may be initially provided to the computing system 400 by downloading it from a remote system through the computing system 400 (e.g., via network adapter 405).

The various embodiments introduced herein can be implemented by, for example, programmable circuitry (e.g., one or more microprocessors, programmed with software and/or firmware), or entirely in special-purpose hardwired circuitry (e.g., non-programmable circuitry), or in a combination of such forms. Special-purpose hardwired circuitry may be in the form of, for example, one or more application-specific integrated circuits (ASICs), programmable logic devices (PLDs), field-programmable gate array (FPGAs), etc.

### CONCLUSION

The embodiments set forth herein represent the necessary information to enable those skilled in the art to practice the embodiments and illustrate the best mode of practicing the embodiments. Upon reading the description in light of the accompanying figures, those skilled in the art will understand the concepts of the disclosure and will recognize applications of these concepts that are not particularly addressed herein. These concepts and applications fall within the scope of the disclosure and the accompanying claims.

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

Reference herein to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method for sequencing user data packets, the method comprising:
receiving, at hardware of a sublayer of a data link layer, a user data packet including a packet data convergence protocol (PDCP) data packet data unit (PDU) header;
decoding, at the sublayer, the PDCP data PDU header to obtain a sequence number of the user data packet;
queueing, at the sublayer, the received user data packet according to the sequence number of the user data packet to assemble a set of consecutively numbered user data packets; and
delivering at least a portion of the set of consecutively numbered user data packets from the sublayer to another sublayer of the data link layer.

2. The method of claim 1, wherein the user data packet is a first user data packet, the PDCP data PDU header is a first PDCP data PDU header, and the sequence number is a first sequence number, the method further comprising:
mapping, at the sublayer, a first queue location of a set of consecutive queue locations to the first sequence number of the first user data packet;
causing, at the sublayer, placement of the first user data packet at the first queue location of the set of consecutive queue locations,
wherein each queue location of the set of consecutive queue locations is matched with a sequence number of a set of sequence numbers;
receiving, at the sublayer, a second user data packet including a second PDCP data PDU header;
decoding, at the sublayer, the second PDCP data PDU header to obtain a second sequence number of the second user data packet,
wherein the second sequence number is numerically nonconsecutive relative to the first sequence number;
mapping, at the sublayer, a second queue location of the set of consecutive queue locations to the second sequence number of the second user data packet;
determining, at the sublayer, one or more intermediate queue locations between the first queue location and the second queue location; and
causing, at the sublayer, placement of the second user data packet at the mapped second queue location of the set of consecutive queue locations,
wherein the set of consecutive queue locations includes the first user data packet, the second user data packet, and the one or more intermediate queue locations.

3. The method of claim 2 further comprising:
initiating a timer upon determining the one or more intermediate queue locations; and
in response to the timer expiring, delivering the set of consecutive queue locations to the sublayer regardless of the one or more intermediate queue locations being filled with any user data packets.

4. The method of claim 2 further comprising, prior to inserting the second user data packet at the mapped second queue location:
in response to determining the one or more intermediate queue locations, storing at least the second user data packet at an external memory.

5. The method of claim 1 further comprising:
mapping, at the sublayer, a queue location of a set of consecutive queue locations to the sequence number of the user data packet;
causing, at the sublayer, placement of the user data packet at the mapped queue location of the set of consecutive queue locations,
wherein each queue location of the set of consecutive queue locations is matched with a sequence number of a set of sequence numbers;
determining that a first queue location of the set of consecutive queue locations does not include a first user data packet,
wherein the first queue location is matched with a lowest sequence number of the set of sequence numbers;
in response to determining that the first queue location does not include the first user data packet, initiating a timer; and
in response to the timer expiring, delivering the set of consecutively numbered user data packets to the other sublayer.

6. The method of claim 1, wherein the other sublayer receives the set of consecutively numbered user data packets from a Radio Link Control (RLC) layer.

7. The method of claim 1 further comprising:
in response to delivering at least the portion of the set of consecutively numbered user data packets to the sublayer, receiving a second user data packet associated with a second sequence number, the second sequence number being numerically consecutive with the set of consecutively numbered user data packets; and
delivering the second user data packet to the other sublayer.

8. The method of claim 1, wherein the sublayer is a medium access control (MAC) sublayer of the data link layer and the other sublayer is a service data adaptation protocol (SDAP) sublayer of the data link layer.

9. The method of claim 1, wherein the user data packet includes a radio link control (RLC) header, the method further comprising, in response to receiving the user data packet:
decoding, at the sublayer, the RLC header to determine that the user data packet is unsegmented; and
decoding, at the sublayer, the PDCP data PDU header to determine that the user data packet is not a control data packet.

10. The method of claim 9, wherein decoding the PDCP data PDU header further comprises:
differentiating between control data and user data.

11. The method of claim 1, wherein the at least the portion of the set of consecutively numbered user data packets are stored in local memory prior to delivery to the other sublayer.

12. A method for sequencing user data packets comprising:
receiving, at a hardware of a sublayer of a data link layer, a plurality of data packets,
wherein each data packet includes a packet data convergence protocol (PDCP) header and a radio link control (RLC) header, and
wherein each data packet includes a PDCP data packet data unit (PDU);
for each data packet:
decoding, at the sublayer, the PDCP header to determine that the data packet includes a data PDU rather than a control PDU;
decoding, at the sublayer, the RLC header to determine that the data packet includes an unsegmented PDCP data PDU rather than a segmented PDCP data PDU, and
in response to determining that the data packet includes the PDCP data PDU that is unsegmented, decoding, at the sublayer, the PDCP header to obtain a sequence number of the PDCP data PDU;
queueing, at the sublayer, the plurality of data packets according to the sequence number of each PDCP data PDU of the plurality of data packets to assemble at least a portion of a set of consecutively numbered PDCP data PDUs; and
causing, at the sublayer, another sublayer of the data link layer to receive the at least the portion of the set of consecutively numbered PDCP data PDUs.

13. The method of claim 12, wherein the plurality of data packets is a first plurality of data packets, the method further comprising:
mapping, at the sublayer, a queue location of a first set of consecutive queue locations with the sequence number of each PDCP data PDU of the first plurality of data packets;
filling, at the sublayer, the first set of consecutive queue locations with the PDCP data PDUs of the first plurality of data packets;
receiving, at the sublayer, a second plurality of data packets,
wherein each data packet of the second plurality of data packets includes a corresponding PDCP header and a corresponding PDCP data PDU;
for each data packet of the second plurality of data packets:
decoding, at the sublayer, the corresponding PDCP data PDU to obtain the sequence number of the corresponding PDCP data PDU; and
determining, at the sublayer, that the sequence number is numerically nonconsecutive with the set of consecutively numbered PDCP data PDUs;
mapping, at the sublayer, each queue location of a second set of consecutive queue locations with the sequence number of each corresponding PDCP data PDU of the second plurality of data packets;
filling, at the sublayer, at least a portion of the second set of consecutive queue locations with the corresponding PDCP data PDUs of the second plurality of data packets,
wherein the second set of consecutive queue locations is numerically consecutive with the first set of consecutive queue locations; and
determining, at the sublayer, one or more intermediate queue locations between the first set of consecutive queue locations and the second set of consecutive queue locations,
wherein the intermediate queue locations do not include corresponding PDCP data PDUs.

14. The method of claim 13, further comprising:
initiating a timer upon determining the one or more intermediate queue locations; and
in response to the timer expiring, delivering the PDCP data PDUs of the second plurality of data packets to a service data adaptation protocol (SDAP) sublayer.

15. The method of claim 13, wherein a first queue location of the set of consecutive queue locations does not include a first PDCP data PDU, and wherein the first queue location is penultimate in a set of consecutively numbered queue locations, the method further comprising:
initiating a timer; and
in response to the first PDCP data PDU being inserted into the first queue location prior to the timer expiring, delivering the set of consecutively numbered PDCP data PDUs to the other sublayer.

16. The method of claim 13, wherein the first set of consecutive queue locations is numerically nonconsecutive with the second set of consecutive queue locations, the method further comprising:
determining that there are two or more intermediate queue locations between the first set of consecutive queue locations and the second set of consecutive queue locations; and
delivering the first set of consecutive queue locations to the other sublayer.

17. The method of claim 1 performed in layer 2 of a 5th generation new radio (5G-NR) system during downlink in a data plane.

18. A system for sequencing user data packets comprising:
a processor; and
a memory having instructions stored thereon that, when executed by the processor, cause the system to:
receive, at a hardware of a sublayer of a data link layer, a user data packet including a packet data convergence protocol (PDCP) data packet data unit (PDU) header;
decode, at the sublayer, the PDCP data PDU header to obtain a sequence number of the user data packet;
queue, at the sublayer, the received user data packet according to the decoded sequence number of the user data packet to assemble a set of consecutively numbered user data packets; and
deliver, at the sublayer, at least a portion of the set of consecutively numbered user data packets to another sublayer of the data link layer.

19. The system of claim 18 further comprising:
a communication interface operable to communicate with an external memory device; and
a timer operable to communicate, via the communication interface, with the processor.

20. The system of claim 18 further comprising:
a handheld mobile device, the handheld mobile device including the processor and the memory.
